(19) United States
(12) Patent Application Publication
(10) Pub. No.: US 2013/0262037 A1
(43) Pub. Date: Oct. 3, 2013

(54) PARTIAL DISCHARGE NOISE SEPARATION METHOD

(71) Applicants: HUSSAIN AL-DUWAISH, DHAHRAN (SA); ZAKARIYA AL-HAMOUZ, DHAHRAN (SA); SYED ZEESHAN RIZVI, DHAHRAN (SA)

(72) Inventors: HUSSAIN AL-DUWAISH, DHAHRAN (SA); ZAKARIYA AL-HAMOUZ, DHAHRAN (SA); SYED ZEESHAN RIZVI, DHAHRAN (SA)

(73) Assignee: KING FAHD UNIVERSITY OF PETROLEUM AND MINERALS, DHAHRAN (SA)

(21) Appl. No.: 13/438,651

(22) Filed: Apr. 3, 2012

(51) Int. Cl. G06F 15/00

(52) U.S. Cl. 702/191

(57) ABSTRACT

The partial discharge noise separation method uses Independent Component Analysis (ICA) for de-noising partial discharge (PD) test signals having a noise signal component and a partial discharge component. Assuming that the noise signal component and the PD signal component are both statistically independent of each other and non-Gaussian, the ICA algorithm separates the noise component from the PD signal component from two partial discharge test signals acquired from two separate couplers per phase that are connected to the windings of a three-phase rotating machine.

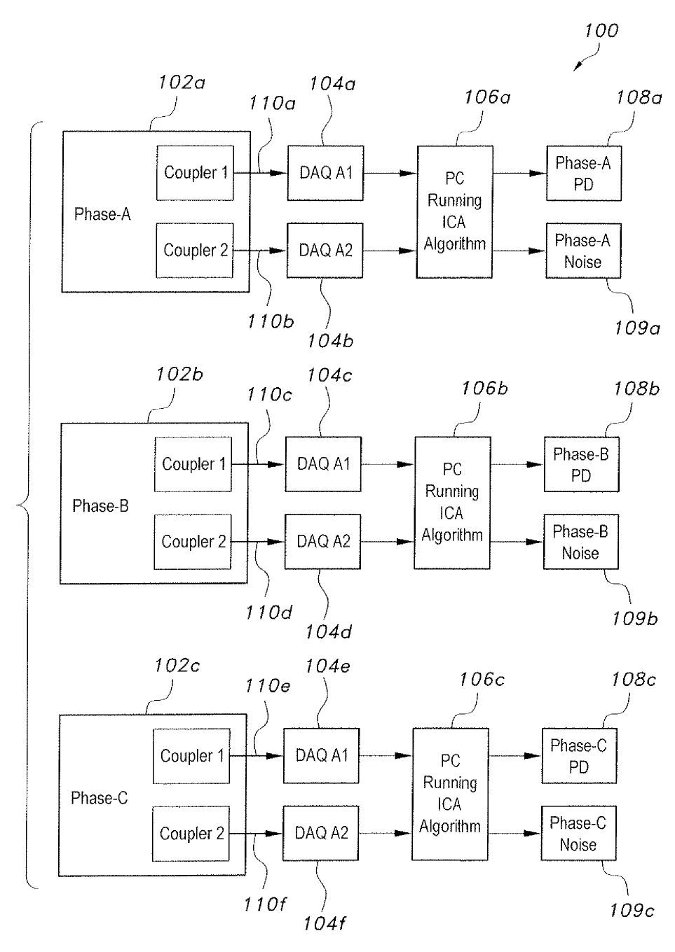

### BACKGROUND OF THE INVENTION

1. Field of the Invention

The present invention relates to electrical motors and power generation systems, and particularly to a partial discharge noise separation method.

2. Description of the Related Art

Partial discharges (PDs) are small electrical sparks that occur in deteriorated or poorly made stator-winding insulation systems in motors and generators rated 3.3 kV and above. Over the past 15 to 20 years, a lot of research efforts have focused on partial discharges. The information extracted from PD testing is then used for fault detection. PD testing leads to detecting manufacturing and deterioration problems in form-wound stator windings, including poor impregnation with epoxy, poorly made semiconductive coatings, insufficient spacing between coils in the end-winding area, loose coils in the slot, overheating and long-term thermal deterioration, winding contamination by moisture, oil or dirt, load cycling problems, and poor electrical connections.

Usual PD tests require energizing the individual phase winding to phase-to-earth voltage from an external source. A blocking capacitor known as the coupler is used to block the power frequency high voltage while allowing the high frequency (Lament impulses of PD to be coupled to the discharge detector. The magnitudes of PD are calibrated in pico coulombs.

One of the key problems faced in PD testing is differentiation of PD signals from external noise signals. Over time, different approaches have been taken by people to de-noise the PD signal acquired, Techniques for de-noising PD data present in the literature have been summarized and include: (a) Frequency domain filtering; (b) Surge-impedance mismatch; (c) Pulse-shape analysis; and (d) Time-of-arrival of noise and PD pulse from two sensors.

Frequency domain filtering is carried out on the basis of frequency range of noise (typically around 10 MHz) and that of PD pulses (usually several hundred MHz). PD detection above 40 MHz provides the highest PD signal to noise ration (SNR) and lowest risk of false indication.

Surge-impedance mismatch uses the difference between the impedance of an air-insulated bus (typically 100Ω), which usually feeds the motors and generators, and the impedance of a coil in a stator slot, which is usually around 30Ω. Due to this mismatch, a noise pulse traveling from the power system to the motor is attenuated to about 25% of its peak value, while a PD pulse current originating in the winding is amplified by about 50% of its peak value, thereby increasing SNR.

Pulse shape analysis uses digital measurement of the rise time of pulses to separate noise from PD pulses on a pulse-by-pulse basis.

The fourth noise separation method involves measurement of time-of-arrival of signals on two different sensors per phase, which are separated by a cabling of at least 2 meters. If a signal arrives at the sensor closer to the power system first, it is easily recognized as noise, and vice versa. Examples include the use of two high frequency capacitors (50 pF, 15 kV) per phase, separated by at least 2 meters of bus or cable. The noise can then be distinguished from stator PD by examination of direction-of-pulse travel and time-of-arrival of pulses.

A pulse detected first at the coupler nearest to the stator winding (coupler N) indicates that the pulse was caused by stator PD. The opposite is true for noise. Other examples include PD monitoring with two couplers per phase, and hence six per machine.

Other methods of detecting partial discharge include a pattern classifier, a discrete wavelet transform (DWT), the time-of-arrival method, Daubechies mother wavelets, and soft thresholding to de-noise acquired PD signals.

Thus, a partial discharge noise separation method solving the aforementioned problems is desired.

### SUMMARY OF THE INVENTION

The partial discharge (PD) noise separation method is utilized on rotating machinery to isolate internal and external noise in order to eliminate the main source of corrupted PD readings. De-noising the PD increases confidence in drawing inferences on the state of stator winding insulation of rotating machines. The partial discharge noise separation method uses two couplers per power generation phase. Independent Component Analysis (ICA) is performed on the two couplers of each phase to separate out the two sub-components of the acquired signal. The ICA finds underlying factors or components of multidimensional statistical data generated at the couplers. The ICA is different from other methods in that it looks for components that are both statistically independent and non-Gaussian. The partial discharge noise separation method provides superior performance than methods in which mere non-co-relatedness is used because independence is a much stronger property than non-co-relatedness.

These and other features of the present invention will become readily apparent upon further review of the following specification and drawings.

### BRIEF DESCRIPTION OF THE DRAWINGS

The sole drawing FIGURE is a block diagram of a motor or generator partial discharge test system implementing a partial discharge noise separation method according to the present invention.

### DETAILED DESCRIPTION OF THE PREFERRED EMBODIMENTS

As shown in the FIGURE, the partial discharge noise separation method utilizes, for testing each phase for partial discharge, two couplers (preferably capacitive) coupled to a single phase of a rotating machine, such as a motor or generator. The couplers may be part of discrete partial discharge testing equipment, or built into the rotating machine for convenience in periodic testing or monitoring The rotary machine has three-phase output, designated Phase A, shown in block 102a, Phase B, shown in block 102b, and Phase C, shown in block 102c. Each phase has two couplers producing outputs 110a, 110b for Phase A 102a, coupler outputs 110c and 110d for Phase B 102b, and coupler outputs 110e and 110f for Phase C 102c. The coupler outputs are partial discharge test signals that include a phase discharge signal component combined with a noise signal component.

Phase A Coupler 1 output 110a feeds data acquisition unit (DAQ) A1, shown in block 104a. Phase A Coupler 2 output 110b feeds DAQ A2, shown in block 104b.

Phase B Coupler 1 output 110c feeds DAQ A1, shown in block 104c. Phase B Coupler 2 output 110d feeds DAQ A2, shown in block 104d.

Phase C Coupler 1 output 110e feeds DAQ A1, shown in block 104e. Phase C Coupler 2 output 110f feeds DAQ A2, shown in block 104f.

Each DAQ pair converts its respective partial discharge test signal to a digital representation, which is fed to a computer running the ICA algorithm implementing the present method. The Phase A DAQ pair feeds ICA process 106a. The Phase B DAQ pair feeds ICA process 106b. Lastly, the Phase C DAQ pair feeds ICA process 106c. The ICA processes 105a, 106b, and 106c separate their respective noisy PD signals into respective distinct Phase A PD signal 108a, Phase A noise signal 109a, Phase B PD signal 108b, Phase B noise signal 109b, and Phase C PD signal 108c and Phase C noise signal 109c. After separation of the noise signals, the partial discharge signal components may be viewed on a display or further analyzed to determine faults in the windings of the rotating machine.

For each phase, the two couplers acquire two observed signals, the magnitude of which are denoted by r₁(t) and r₂(t). The signals r₁(t) and r₂(t) are then denoted by the weighted sum of s(t) and n(t), which represent the PD signal and noise, respectively. The coefficients (matrix members a₁₁ through a₂₂) of s(t) and n(t) depend on the distances between the sources (the winding terminals) and the couplers. The following are the relevant equations:

$$\begin{matrix}{r}_{1} ( t ) = {a}_{11} s ( t ) + {a}_{12} n ( t ) , & ( 1 ) \\ {r}_{2} ( t ) = {a}_{21} s ( t ) + {a}_{22} n ( t ) , & ( 2 ) \\ ( \begin{matrix}{r}_{1} ( t ) \\ {r}_{2} ( t )\end{matrix} ) = A ( \begin{matrix}s ( t ) \\ n ( t )\end{matrix} ) . & ( 3 )\end{matrix}$$

The goal is that the original signals s(t) and n(t) are recovered from the observed signals r₁(t) and r₂(t). The problem at hand is a blind-source separation (BSS) problem, the term blind indicating lack of a priori knowledge on the original sources of observed signals. Assuming that the coefficients aᵢⱼ are different enough to make the matrix that they form invertible, there exists a matrix W, such that s(t) and n(t) can be separated.

$$\begin{matrix}s ( t ) = {w}_{11} {r}_{1} ( t ) + {w}_{12} {r}_{2} ( t ) , & ( 4 ) \\ n ( t ) = {w}_{21} {r}_{1} ( t ) + {w}_{22} {r}_{2} ( t ) , & ( 5 ) \\ ( \begin{matrix}s ( t ) \\ n ( t )\end{matrix} ) = W ( \begin{matrix}{r}_{1} ( t ) \\ {r}_{2} ( t )\end{matrix} ) , & ( 6 )\end{matrix}$$

where the matrix W is the inverse of the matrix A. According to Hyvarinen et al. (Hyvarinen, Karhunen and Oja, “Independent Component Analysis,” John Wiley and Sons, 2001), if the signals are statistically independent and non-Gaussian, it is enough to determine the coefficients using a FastICA® algorithm available from the FastICA Team, Laboratory of Computer and Information Science, P.O. Box 9800 FIN-02015 HUT Finland.

FastICA® for a one-neural-unit consists of a weight vector w that the neuron is able to update by a learning rule. The FastICA® learning rule finds a unit vector w such that the projection w^{T}r(t) maximizes non-Gaussianity. Non-Gaussianity is measured by the approximation of negentropy J{w^{T}r(t)}.

Negentropy is a slightly modified version of differential entropy, a basic measure of randomness in information theory. The entropy of a random variable is the degree of information that the observation of the variable provides. The more random, i.e., unpredictable and unstructured a variable is, the larger is its entropy. A fundamental concept of information theory is that a Gaussian variable has the largest entropy among all random variables of equal variance. This means that entropy can be used as a measure of non-Gaussianity. To obtain a measure of non-Gaussianity that is zero for a Gaussian variable and always nonnegative, a more appropriate variant of it, the Negentropy is used. Negentropy J(y) for a variable y is given as:

J(y)=H(y_{Gaussian})−H(y) (7)

where y_{Gaussian} is a random variable of the same covariance matrix as y and H(y) denotes differential entropy, which is given as:

H(y)=∫f(y)log f(y)dy (8)

The variable f(y) denotes the density of random variable y. It should be noted that the variance of w^{T}r(t) must be constrained to unity. The FastICA® algorithm works in the following sequential steps, summarized in Table 1.

TABLE 1
Steps in a FastICA algorithm

| | |
|---|---|
| Step 1. | Random initialization of weight vector w |
| Step 2. | Let w⁺ = E[xg(w^{T}r)] − E[g′(w^{T}r)]w |
| Step 3. | $Let w = \frac{{w}^{+}}{‖ {w}^{+} ‖}$ |
| Step 4. | If not converged, go back to step 2 |

The variable g in step 2 denotes the derivative of non-quadratic function G, which, if chosen wisely such that it does not grow too fast, permits one to obtain more robust estimators. Expansion of step 2 is obtained by using Newton's method. Convergence in FastICA® means that the dot product of old and new values of w are equal to or close to 1 (i.e., w≈1).

The present method contemplates the fact that the problem of blind source separation reduces to finding a linear representation in which the components are statistically independent. In practical situations, the noise and PD might not have a general representation where they are really independent, but a representation can be found in which the two components are as independent as possible.

It should be understood that the assumption that the number of observed signals is equal to the number of independent components is a simplifying assumption and is not completely necessary. Moreover, the model in equations 3 and 6 can be estimated only if the components are non-Gaussian. This fundamental requirement makes the ICA different from other separation techniques, such as Factor Analysis.

It is to be understood that the present invention is not limited to the embodiments described above, but encompasses any and all embodiments within the scope of the following claims.

We claim:

1. A method of separating a partial discharge signal from a noise signal during partial discharge testing of windings of a three-phase rotating machine, comprising the steps of:
connecting two couplers per output phase to the windings of the machine;
acquiring a partial discharge test signal at the couplers, the partial discharge test signal containing a partial discharge signal component and a noise signal component;
converting the partial discharge test signal from each of the couplers to a digital representation of the signal using a data acquisition unit;
for each of the phases, processing the digital representation of the partial discharge test signal from each of the two couplers using an Independent Component Analysis algorithm to executed by a computer to separate the partial discharge signal component from the noise signal component; and
analyzing the partial discharge signal component for each of the phases to determine faults in the windings of the three-phase rotating machine.

2. The method of separating a partial discharge signal from a noise signal according to claim 1, wherein said step of processing the digital representation further comprises the step of maximizing non-Gaussianity of a linear combination of the partial discharge signal component and the noise signal component.

3. The method of separating a partial discharge signal from a noise signal according to claim 2, wherein said non-Gaussianity maximizing step further comprises the steps of:
(a) randomly initializing a weight vector w;
(b) assigning w⁺=E[xg(w^{T}r)]−E[g′(w^{T}r)]w;
(c) assigning
$$w = \frac{{w}^{+}}{‖ {w}^{+} ‖} ;$$
and
(d) repeating steps b and c until converged such that a clot product of old and new values of w≈1.

4. The method of separating a partial discharge signal from a noise signal according to claim 3, wherein said non-Gaussianity maximizing step further comprises the step of maximizing negative entropy (negentropy) defined as J(y)=H(y_{Gaussian})−H(y), wherein y_{Gaussian} is a random variable of a same covariance matrix as random variable y, and H(y) denotes differential entropy which is defined as:
H(y)=∫f(y)log f(y)dy,
where variable f(y) denotes density of the random variable y.

5. The method of separating a partial discharge signal from a noise signal according to claim 4, wherein said non-Gaussianity maximizing step further comprises the steps of:
for each of the phases, representing the partial discharge test signals as having a magnitude denoted as r₁(t) and r₂(t), wherein the signal r₁(t) is denoted by a weighted sum of s(t) and n(t) representing the partial discharge signal component and the noise signal component, respectively;
denoting the weights of the partial discharge signal component and the noise signal component by coefficients a₁₁ through a₂₂ that depend upon distances between the windings and the couplers so that r₁(t)=a₁₁s(t)+a₁₂n(t) and r₂(t)=a₂₁s(t)+a₂₂n(t);
to formulating a matrix equation as:
$$( \begin{matrix}{r}_{1} ( t ) \\ {r}_{2} ( t )\end{matrix} ) = A ( \begin{matrix}s ( t ) \\ n ( t )\end{matrix} ) ;$$
formulating a matrix W, W being the inverse of matrix A so that
$$( \begin{matrix}s ( t ) \\ n ( t )\end{matrix} ) = W ( \begin{matrix}{r}_{1} ( t ) \\ {r}_{2} ( t )\end{matrix} ) ;$$
and
separating the signals s(t) and n(t) using the relations:
s(t)=w₁₁r₁(t)+w₁₂r₂(t) and n(t)=w₂₁r₁(t)+w₂₂r₂(t); and
whereby the signals s(t) and n(t) are recovered from said observed signals r₁(t) and r₂(t).

6. A system for separating a partial discharge signal from a noise signal during partial discharge testing of windings of a three-phase rotating machine, comprising:
two couplers adapted for connection to each phase of the three-phase rotating machine, the couplers having means for acquiring a partial discharge test signal containing a partial discharge signal component and a noise signal component;
a data acquisition unit connecting to the two couplers, the data acquisition unit having means for converting the partial discharge test signal from each of the couplers to a digital representation of the signal; and
a processing unit connected to the data acquisition unit, the processing unit having means for processing the digital representation of the partial discharge test signal from each of the two couplers using an Independent Component Analysis algorithm to separate the partial discharge signal component from the noise signal component.

7. The system for separating a partial discharge signal from a noise signal according to claim 6, wherein said means for performing Independent Component Analysis further comprises means for maximizing non-Gaussianity of a linear combination of the partial discharge signal component and the noise signal component.

8. The electrical machinery according to claim 7, wherein said means for maximizing non-Gaussianity further comprises:
(a) means for randomly initializing a weight vector w;
(b) means for assigning w⁺=E[xg(w^{T}r)]−E[g′(w^{T}r)]w;
(c) means for assigning
$$w = \frac{{w}^{+}}{‖ {w}^{+} ‖} ;$$
and
(d) means for repetitively assigning values to w⁺ and w using the means of elements (b) and (c) until convergence so that a dot product of old and new values of w≈1.

9. The electrical machinery according to claim 8, wherein said means for maximizing non-Gaussianity further comprises means for maximizing negative entropy (negentropy) defined as J(y)=H(y_{Gaussian})−H(y), wherein y_{Gaussian} is a random variable of a same covariance matrix as y and H(y) denotes differential entropy which is given as:
H(y)=f(y)log f(y)dy,
where said variable f(y) denotes density of random variable y.

10. The electrical machinery according to claim 9, wherein said means for processing comprises:
means for representing the partial discharge signal component and the noise signal component as having magnitudes denoted as r₁(t) and, respectively r₂(t), wherein the signal r₁(t) is denoted by a weighted sum of s(t) and n(t) representing the partial discharge signal component and the noise signal component, respectively;
means for denoting the weights of the partial discharge signal component and the noise signal component by coefficients a₁₁ through a₂₂ that depend upon distances between the windings and the couplers so that r₁(t)=a₁₁s(t)+a₁₂n(t) and r₂(t)=a₂₁s(t)+a₂₂n(t);
means for formulating a matrix equation as:
$$( \begin{matrix}{r}_{1} ( t ) \\ {r}_{2} ( t )\end{matrix} ) = A ( \begin{matrix}s ( t ) \\ n ( t )\end{matrix} ) ;$$
means for formulating a matrix W, W being the inverse of matrix A so that
$$( \begin{matrix}s ( t ) \\ n ( t )\end{matrix} ) = W ( \begin{matrix}{r}_{1} ( t ) \\ {r}_{2} ( t )\end{matrix} ) ;$$
and
means for separating the signals s(t) and n(t) using the relations:
s(t)=w₁₁r₁(t)+w₁₂r₂(t) and n(t)=w₂₁r₁(t)+w₂₂r₂(t); and
whereby the signals s(t) and n(t) are recovered from said observed signals r₁(t) and r₂(t).
